(19) United States
(12) Patent Application Publication
(10) Pub. No.: US 2006/0123378 A1
(43) Pub. Date: Jun. 8, 2006

(54) Method, System, and Software Product For Using Synthesizable Semiconductor Intellectual Property In Self-Documenting Electronic Extended Package

(75) Inventors: Michael Cizl, Poing (DE); Thomas Warren Savage, San Jose, CA (US)

Correspondence Address: PATENTRY, 300 MURCHISON DRIVE, SUITE 218, MILLBRAE, CA, 94030, US

(73) Assignee: IPextreme Inc., Campbell, CA (US)

(21) Appl. No.: 10/904,914

(22) Filed: Dec. 3, 2004

(51) Int. Cl. G06F 17/50; G06F 9/455

(52) U.S. Cl. 716/18; 716/11; 716/1

(57) ABSTRACT

A method of synthesizing custom semiconductor circuits from an electronically editable datasheet of configurations and specifications for a functional component, by editing the parameters of the datasheet, checking for validity and consistency within said electronically editable datasheet, building a database of desired constraints and configurations, generating a plurality of files containing script, and directives for a targeted design automation software product, and synthesizing a manufacturable netlist to meet the configuration and specification desired by the enduser.

### FIELD OF THE INVENTION

The invention relates generally to computer software program products and more particularly to automation of electronic design of semiconductor circuits.

### BACKGROUND

As semiconductor manufacturing has scaled dramatically, the capacity of very large scale integration to hold more functionality has exceeded the productivity of small groups of designers. Growing the number of teams becomes both uneconomical as well as unwieldy, where coordination between the members of a large team cancels out any improvement in throughput. Thus a small highly focused team must individually generate more design functionality, typically done by reusing existing designs. This is referred to as intellectual property reuse.

Problem: To reuse circuits designed by others and apply them to a new purpose has required detailed study of the written documentation and even discussion of assumptions made by the original authors. Generally these circuits must be resynthesized according to the specific application and the latest manufacturing technologies.

Thus what is needed is a method of capturing the knowhow of the original authors and enabling endusers to reuse the circuits in a newer form and integrated with previously unanticipated applications without personal exchange and extensive education for technology transfer. In current reuse scenarios, large quantities of documentation must be written and then understood for synthesizable circuits to be understood enough to be resynthesized and reused by other than the original authors.

Thus it can be appreciated that what is needed is a way to package previously successful synthesized circuits so that functionality can be reused by those unskilled in the art of implementing that specific functionality but appreciating the parameters and specifications of that functionality as a black box or system component.

### INVENTION SUMMARY

The present invention is a software program product, system, and method of synthesizing custom semiconductor circuits to meet configurations and specifications desired by the enduser. A system comprising a logic synthesis engine, a configurable synthesizable language description of circuit, a plurality of scripts and configuration files to constrain the logic synthesis engine, a generator to read a database of desired capabilities and emit script and configuration files in a selected and tailored format consistent with a chosen logic synthesis engine, a database of desired circuit configurations and constraints, a transformational program that converts data entered into or selected on an electronic datasheet into a database, an electronic datasheet with fields that are user editable or selectable that describes the functionality of a semiconductor circuit and the choices or ranges which are allowed for a configurable synthesizable language description of said semiconductor circuit. The electronic datasheet with user input also serves as compact and portable documentation of intent, desire, requirement, or achievement.

### SUMMARY OF FIGURES

FIG. 1, Configuration Spreadsheet

FIG. 2, Constraint Spreadsheet

FIG. 3, Result Window

FIG. 4, Flowchart

### DETAILED DISCLOSURE

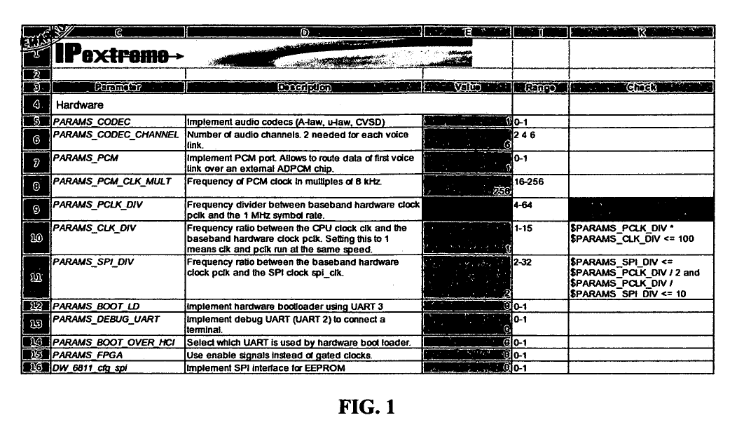

Referring now to FIG. 1, Configuration Spreadsheet is the main vehicle that contains all relevant data to describe and configure an IP core. The user can adjust the relevant data to the actual requirements of an application. This data can be categorized into two groups, the configuration parameters and the timing constraints. The configuration parameters allow the user to select/deselect features of the IP. This will drive the hardware implementation later during the implementation process of the IP. The spreadsheet checks the correctness of the configuration while the user modifies the parameter values. In one embodiment, one line contains red colored cells indicating an error in the user configuration, i.e. the user has to go back and fix the parameter (or one of the other parameters used in the validity check expression of that parameter).

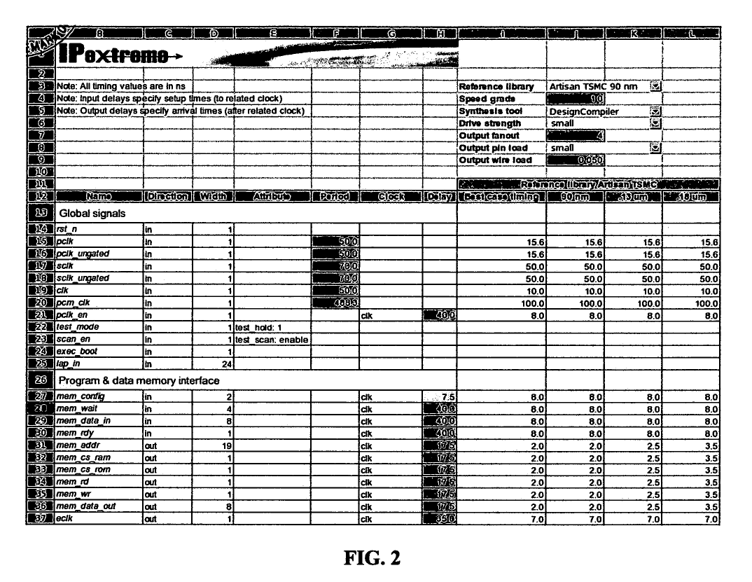

Referring now to FIG. 2 Constraints Spreadsheet, the timing constraints allow the user to define the required timing of the IP. These constraints are used later during RTL synthesis of the IP to steer the synthesizer to obtain an optimal implementation. The spreadsheet allows the user to specify the period of all clocks, the timing of all data inputs and data outputs and environmental settings (drive capabilities and load capacitances). As for the configuration parameters, the spreadsheet checks the constraints while the user modifies the values. In an embodiment one cell is yellow colored indicating that this port is over-constrained. The spreadsheet actually does not force the user to relax this value. The timing check is based on synthesis results using three different reference libraries. The reference data is contained in the spreadsheet.

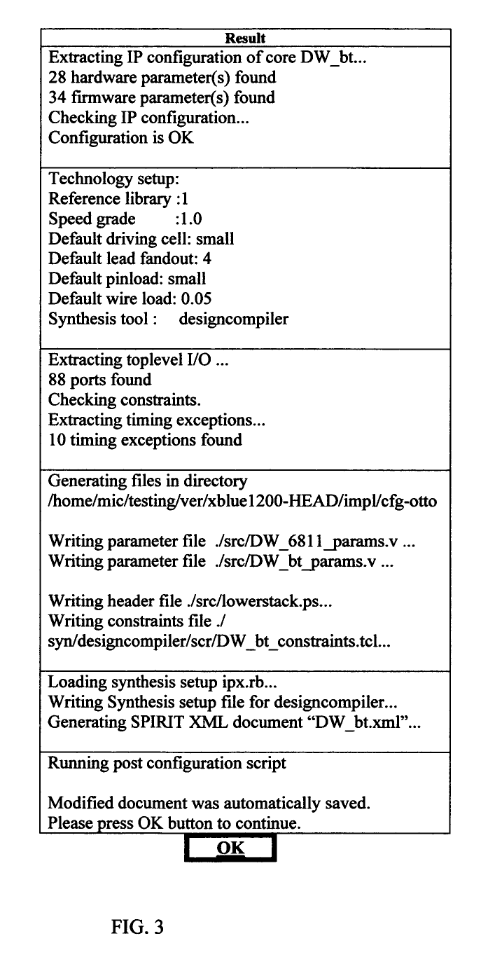

Referring now to FIG. 3 Result Window. Once the IP configuration is completed, the user initiates the script generation. The result can be viewed when the generation has completed. The interface to the script generator is declared in the next section.

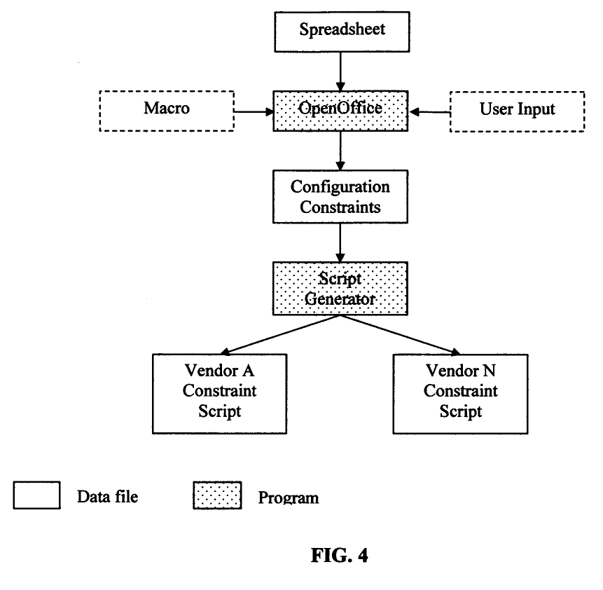

Referring now to FIG. 4, Flowchart, which shows the general flow from the spreadsheet to the generated constraint script. The spreadsheet and the script generator are connected through a loose interface. The spreadsheet writes out a configuration file containing all the input data necessary to generate both constraints and compile script. The way the spreadsheet displays the data is only on embodiment of the invention. The spreadsheet uses a facility to generate the configuration file and run the script generator on user request.

The format of the configuration file is also implementation dependent. One possible format for the configuration file may be a comma separated ASCII table where each line contains the definition of one port, timing exception, the selected target technology and other useful information.

The minimum information for each port must include name, type, direction and width. Additional entries depend on the type of the port. The clock period must be added for clock ports. The delay value must be added for all synchronous data inputs and outputs. Asynchronous resets and static inputs do not need any timing information. Timing exceptions are categorized into false paths and multi-cycle paths. It must be possible to specify any valid combination of from, through and to timing points. The timing points can be pins, ports or clocks.

For each specific synthesizable semiconductor intellectual property circuit, a spreadsheet is created that provides description and data about the functionality and capability of the intellectual property corresponding to the nature of a datasheet for a standard electronic component. However, elements of the electronic datasheet are associated with macros when the spreadsheet is opened with a product such as OpenOffice which allows interaction by a user. The user, typically a designer of a larger system on chip, wishes to embed the selected IP functionality into his system on chip design and configure it to integrate with other functions. The user selects a configuration and sets constraints by editing fields on the spreadsheet and saving it under another name. The saved spreadsheet documents his desired results in a database of configuration constraints. The database is read and analyzed by the Script Generator which has selectable output modules according to the electronic design automation (EDA) software vendor chosen by the user for logic synthesis. Thus a selected functional semiconductor intellectual property circuit could be targeted to a plurality of logic synthesis tools by generating a plurality of vendor-specific constraint scripts.

In summary, the present invention presents the user of synthesizable semiconductor intellectual property with an electronic datasheet to control the configuration and constrain the synthesis of a semiconductor electronic circuit.

Herein is disclosed a method of controlling a plurality of logic synthesis tools and a plurality of synthesizable circuit descriptions through a plurality of electronic editable datasheets that present fields enabling a user without deep knowledge of a circuit to specify desired configuration and performance characteristics.

Herein is disclosed a system of building an editable electronic datasheet comprising the steps of describing the functionality of a synthesizable semiconductor circuit, presenting selectable fields and editable values which reflect the valid limits of the synthesizable semiconductor circuit, associating programming code to check consistency between selectable and editable fields and the valid ranges of the synthesizable semiconductor circuit and associating the fields of the datasheet with a database that can be transformed to scripts and files appropriate to a selected logic synthesis tool.

Herein is disclosed a software program product, presenting a choice of logic synthesis tools, and presenting selectable configuration fields, and presenting editable fields, and other information specific to a synthesizable circuit description, the intellectual property, which firstly checks for valid and consistent values selected and entered into its fields, and secondly populates a database which can be read by a number of software modules which in turn emit a plurality of files necessary for the selected logic synthesis tool.

Herein is disclosed a method for specifying, designing, optimizing, and synthesizing a custom intellectual property (IP) core for semiconductor chip manufacturing comprising the steps of firstly selecting said IP core through its associated datasheet, secondly, selecting from a choice or entering data into editable fields of the datasheet, thirdly, saving the information into a database, fourthly, generating a script and associated files according to the logic synthesis tool chosen among the editable fields, and fifthly, calling the logic synthesis to operate on the appropriate files.

Herein is disclosed the generating method comprising the steps of dividing the input data into constraints and implementation directives, constraining the logic synthesis tool to clocks, paths and delays, directing the implementation with compile and report statements, elaborating the design through mapping of circuits to functionality, and finally, compiling the design into a output format.

Herein is disclosed an electronic software program product presenting the appearance of a datasheet with a plurality of editable fields and a stored program for reading the stored values of the spreadsheet and transforming the data into a script customized to the needs of a selected logic synthesis tool.

Herein is disclosed a computer system for describing, specifying, and synthesizing a detailed implementation netlist of a semiconductor electronic circuit comprising: a processing server unit, a client workstation unit, and a computer-readable storage medium encoded with a computer program product which modifies the operation of said computer system by formatting and displaying information and receiving user input by using a client display product from a group consisting of OpenOffice, Microsoft Office, Adobe Acrobat, Internet Explorer, Netscape Navigator, Firefox, and browsers to present a file from the group consisting of Portable Document Format, Hypertext Markup Language, Extended Markup Language, Word, Excel, Powerpoint, rich text format, and OpenOffice format and presenting in fixed text and graphic an electronic datasheet describing the functionality of a configurable and synthesizable semiconductor electronic circuit and presenting editable and selectable fields to enable user input on configuring and constraining the synthesis of said synthesizable semiconductor electronic circuit and storing the user preferences on computer-readable storage medium, and generating scripts, parameter files, and instantiation files to control a logic synthesis program product and launching said logic synthesis program product to create and store a detailed implementation netlist on computer-readable storage medium.

Herein is disclosed the method of controlling the synthesis of semiconductor intellectual property by the steps of firstly, describing the functionality and capability of a synthesizable module in an electronic datasheet, secondly, creating editable tables and fields to represent configuration choices available to the user, thirdly, creating editable tables and fields to represent constraints on the performance of the configured module, fourthly, checking for consistency between the chosen configuration and the desired constraints on performance to be applied to one logic synthesis tool chosen from the group of Synopsys Design Compiler, Symplicity Synplify, Cadence Encounter, and Mentor Graphics Catapult, fifthly creating a synthesis script to attain the specified configuration and desired constraints on performance.

Herein is disclosed that the electronic datasheet may be used with or without successful synthesis and even with errors or conflicts displayed in error notation as a method of communicating to IP Vendors or design team members a desired outcome, or requirement for enhancement, or problem in implementation without transmitting a lengthy document or large database by the steps of editing an electronic datasheet, storing the selected values and constraints, and storing and transmitting it without the associated voluminous semiconductor IP files. Bugs and enhancement requests can be filed by sending the electronic datasheet to the authors or support teams. Coordination across global borders can be done by smaller files.

### BEST MODE

This paragraph discloses an embodiment of the invention's script generator in specifying the input data and the expected generated commands. The input data is divided into constraints and implementation directives. It is EDA vendor neutral. The constraints contain information about clocks, paths and delays. The implementation directives contain compile and report statements using the constraints to implement the IP (run synthesis). While the constraints are different for every IP and even every IP instance, the implementation directives are the same. For the rest of the document, the syntax of generated commands is based on Synopsys SDC format. For any other synthesizer, the syntax must be adopted appropriately.

The following specification is at a level of abstraction enabling one skilled in the art of object oriented programming to convert the specified inputs in tables to the specified outputs in a script file.
Constraints
Clocks
For a clock port, the clock period is specified. The time unit for the clock period is nanoseconds (ns).
Input data:
<port> specifies the name of a clock input
<period> specifies the clock period
Generated command:
create_clock [get_ports <port>]-period <period>
False paths
For asynchronous resets or static inputs, a false path is set in order to tell the synthesizer that it does not optimize the timing from these ports.
Input data:
<port> specifies the name of an asynchronous reset or static input.
Generated command:
set_false_path-from [get_ports <port>]
Input delays
A synchronous data input needs a certain setup time to be correctly clocked into all registers at the end of the fanout-tree of that input. The registers are clocked by one of the existing clock ports. The timing is relative to the positive clock edge.
Input data:
<setup_time> specifies the required setup time of the input
<clock> specifies the clock port connected to the clock pin of the registers
<port> specifies the name of the input
Generated command:
set_input_delay <delay>-max-clock [get_clocks <clock>] [get_ports <port>]
<delay> is the result of the equation <period>-<setup_time>
Output delays
A synchronous data output needs a certain update time to change it's value after one of the registers faning out to that output has changed. The registers are clocked by one of the existing clocks ports. The timing is relative to the positive clock edge.
Input data:
<valid_time> is the required update time of the output
<clock> is the clock port connected to the clock pin of the registers
<port> is the name of the output
Generated command:
set_output_delay <delay>-max-clock [get_clocks <clock>] [get_ports <port>]
<delay> is the result of the equation <period>-<valid_time>
Input-to-output delays (combinational paths)
A combinational path goes from an input to an output without crossing any register.
The delay from the input to the output is just an absolute value and not relative to any clock.
Input data:
<delay> specifies the required time from input to output
<in_port> specifies the name of the input
<out_port> specifies the name of the output
Generated command:
set_max_delay <delay>—from [get_ports <in_port>]—to [get_ports <out_port>]
Internal false paths
An internal false path may be a path between clock domains or a path from/through/to internal pins. False paths between clock domains are used when there is a path from one register driven by clock domain 1 to a register driven by clock domain 2 and these clock domains are asynchronous. Both clocks must be existing clock ports.
Input data for clock domain false paths:
<source_clock> specifies the clock port connected to the clock pin of the driving registers
<sink_clock> specifies the clock port connected to the clock pin of the receiving registers
Generated command:
set_false_path—from [get_clocks <source_clock>]—to [get_clocks <sink_clock>]
False paths using internal pins may have various different flavors. They can just go through some internal pins, or from one internal pin to another internal pin. The paths may also start or end at an input respectively output. These false paths are set if the timing path does not exist functionally or if internal pins can be treated as pseudo-static.
Input data for paths affecting internal pins:
<from_pin> specifies an internal pin as timing start point
<through_pin> specifies an internal pin as timing through point
<to_pin> specifies an internal pin as timing end point
<in_port> specifies an input as timing start point
<out_port> specifies an output as timing end point
Generated commands (list is not complete):
set_false_path-through [get_pins <through_pin>]
set_false_path-from [get_ports <in_port>]-through [get_pins <through_pin>]
set_false_path-through [get_pins <through_pin>]-to [get_ports <out_port>]
set_false_path-from [get_pins <from_pin>]-to [get_pins <to_pin>]
Internal multi-cycle paths
A multi-cycle path relaxes the timing path in multiples of clock cycles in case it is known that the associated timing path can span more than one clock cycle. This can be a timing path between a slow and a fast clock domain with a fixed integer clock ratio or a path where the result of the logic is not needed at the next updating clock edge. Like internal timing paths, various different flavors are possible.
Input data:
<setup> specifies the number of clock cycles for maximum timing
<hold> specifies the number of clock cycles for minimum timing
<from_pin> specifies an internal pin as timing start point
<through_pin> specifies an internal pin as timing through point
<to_pin> specifies an internal pin as timing end point
<in_port> specifies an input as timing start point
<out_port> specifies an output as timing end point
Generated commands (list is not complete):
set_multicycle_path-setup <setup>-through [get_pins <through_pin>]
set_multicycle_path-hold <hold>-through [get_pins <through_pin>]
set_multicycle_path-setup <setup>-from [get_ports <in_port>]\-through [get_pins <through_pin>]
set_multicycle_path-hold <hold>-from [get_-ports <in_port>]\-through [get_pins <through_pin>]
set_multicycle_path-setup <setup>-through [get_pins <through_pin>]\-to [get_ports <out_port>]
set_multicycle_path-hold <hold>-through [get_pins <through_pin>]\-to [get_ports <out_port>]
set_multicycle_path-setup <setup>-from [get_pins <from_pin>]\-to [get_pins <to_pin>]
set_multicycle_path-hold <hold>-from [get_pins <from_pin>]\-to [get_pins <to_pin>]
Implementation Directives
The implementation directives are based on a fixed flow. The flow applies a standard synthesis optimization and the result is a mapped netlist.
Analyze
The first implementation step is to analyze the RTL source code.
Input data:
<source_files> specifies the complete list of RTL source files
<language> specifies the hardware description language
Generated commands:
define_design_lib work-path ./lib
analyze-library work-format <language> <source_files>
Elaborate
The elobarate step extracts the registers and the logic function of the design and maps it to generic cells while applying Boolean optimizations.
Input data:
<design> specifies the name of the toplevel module
Generated command:
elaborate <design>
Compile
The compile step is the final implementation step mapping the elaborated design to cells of the selected target technology library and performing all necessary optimizations to meet the timing constraints.
Input data:
<file> specifies the name of the constraints file
Generated command:
source <file>
compile-map_effort high-scan-boundary_optimization
Save
The design is saved at the end of the implementation.
Input data:
<design>specifies the name of the toplevel module to be saved
Generated command:
write-format db-hierarchy-output <design>.db
Report timing

The timing report allows to check whether all timing constraints are met.
Input data:
<file> specifies the name of the report file
Generate command:
report_timing> <file>
Synthesizer call
The previous showed commands are all stored in a single script. The synthesizer is called with this script.
Input data:
<file> specifies the name of the script
Generated UNIX shell command:
dc_shell-tcl-f <script>

The foregoing description of the embodiments of the invention are to be considered in all respects as illustrative and not restrictive, the scope of the invention being indicated by the appended claims rather than by the foregoing description, and all changes that come within the meaning and range of equivalency of the claims therefore are intended to be embraced therein. The embodiment described is selected to best explain the principles of the invention and its practical application to thereby enable others skilled in the art to best utilize the invention in various embodiments and with various modifications as suited to the particular purpose contemplated. In particular, Applicants contemplate that functional implementation of invention described herein may be implemented equivalently in hardware, software, firmware, and/or other available functional components or building blocks. Other variations and embodiments are possible in light of the above teachings, and it is thus intended that the scope of the invention not be limited by this Detailed Description, but rather by claims following.

What is claimed is:

1. A method of controlling a plurality of logic synthesis tools and a plurality of synthesizable circuit descriptions comprising the steps of building and editing a plurality of electronic editable datasheets that present fields enabling a user without deep knowledge of a circuit to specify desired configuration and performance characteristics.

2. The method of claim 1 for building an editable electronic datasheet comprising the steps of describing the functionality of a synthesizable semiconductor circuit, presenting selectable fields and editable values which reflect the valid limits of the synthesizable semiconductor circuit, associating programming code to check consistency between selectable and editable fields and the valid ranges of the synthesizable semiconductor circuit and associating the fields of the datasheet with a database that can be transformed to scripts and files appropriate to a selected logic synthesis tool.

3. A software program product, presenting a choice of logic synthesis tools, and presenting selectable configuration fields, and presenting editable fields, and other information specific to a synthesizable circuit description, the intellectual property, which firstly checks for valid and consistent values selected and entered into its fields, and secondly populates a database which can be read by a number of software modules which in turn emit a plurality of files necessary for the selected logic synthesis tool.

4. A method for specifying, designing, optimizing, and synthesizing a custom intellectual property (IP) core for semiconductor chip manufacturing comprising the steps of firstly selecting said IP core through its associated datasheet, secondly, selecting from a choice or entering data into editable fields of the datasheet, thirdly, saving the information into a database, fourthly, generating a script and associated files according to the logic synthesis tool chosen among the editable fields, and fifthly, calling the logic synthesis to operate on the appropriate files.

5. The generating step of claim 4 comprising the steps of dividing the input data into constraints and implementation directives, constraining a logic synthesis tool from the group consisting of Synopsys Design Compiler, Mentor Graphics Catapult, Synplicity Synplify, and Cadence Encounter, to clocks, paths and delays, directing the implementation with compile and report statements suitable for the user selected logic synthesis tool, elaborating the design through mapping of circuits to functionality, and finally, compiling the design into a output format.

6. The method of claim 4 further comprising the steps of presenting the appearance of a datasheet with a plurality of editable fields, reading the stored values of the spreadsheet and transforming the data into a script customized to the needs of a selected logic synthesis tool.

7. A computer system for describing, specifying, and synthesizing a detailed implementation netlist of a semiconductor electronic circuit comprising: a processing server unit, a client workstation unit, and a computer-readable storage medium encoded with a computer program product which modifies the operation of said computer system by formatting and displaying information and receiving user input by using a client display product from a group consisting of OpenOffice, Microsoft Office, Adobe Acrobat, Internet Explorer, Netscape Navigator, Firefox, and browsers to present a file from the group consisting of Portable Document Format, Hypertext Markup Language, Extended Markup Language, Word, Excel, Powerpoint, rich text format, and OpenOffice format and presenting in fixed text and graphic an electronic datasheet describing the functionality of a configurable and synthesizable semiconductor electronic circuit and presenting editable and selectable fields to enable user input on configuring and constraining the synthesis of said synthesizable semiconductor electronic circuit and storing the user preferences on computer-readable storage medium, and generating scripts, parameter files, and instantiation files to control a logic synthesis program product and launching said logic synthesis program product to create and store a detailed implementation netlist on computer-readable storage medium.

8. A method of controlling the synthesis of semiconductor intellectual property by the steps of firstly, describing the functionality and capability of a synthesizable module in an electronic datasheet, secondly, creating editable tables and fields to represent configuration choices available to the user, thirdly, creating editable tables and field to represent constraints on the performance of the configured module, fourthly, checking for consistency between the chosen configuration and the desired constraints on performance to be applied to one logic synthesis tool chosen from the group of Synopsys Design Compiler, Symplicity Synplify, Cadence Encounter, and Mentor Graphics Catapult, fifthly creating a synthesis script to attain the specified configuration and desired constraints on performance.

9. A method of communicating to IP Vendors or design team members a desired outcome, or requirement for enhancement, or problem in implementation without transmitting a lengthy document or large database by the steps of editing an electronic datasheet, storing the selected values and constraints, and storing and transmitting it without the associated voluminous semiconductor IP files.
